(19) United States
(12) Patent Application Publication
(10) Pub. No.: US 2010/0198425 A1
(43) Pub. Date: Aug. 5, 2010

(54) PROGRAMMABLE THERMOSTAT

(76) Inventor: Paul Donovan, Halifax (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 12/365,677

(22) Filed: Feb. 4, 2009

(51) Int. Cl. G05D 23/00; H01H 43/02

(52) U.S. Cl. 700/299; 700/306

(57) ABSTRACT

A programmable thermostat is disclosed having a continuously movable indexing mechanism, such as a rotatable wheel, that allows a user to scroll or cycle through sequential time intervals ranging over a complete week to view currently programmed time intervals and to select periods of time during the week that the user wishes to program or reprogram. Such a design allows a user to easily program different temperature settings during different time intervals during the week and allows the user to easily view the programmed settings.

### FIELD OF THE INVENTION

The present invention relates generally to programmable thermostats.

### DESCRIPTION OF THE PRIOR ART

A programmable thermostat is a thermostat that may be programmed by a user to automatically adjust the temperature of a room or building during selected periods of the day and/or week. Programmable thermostats generally result in energy savings since the thermostat may be programmed to allow the temperature in the building to rise (in the summer) or lower (in the winter) during periods of time when the reduced amount of heating or cooling would not be objected to by the patrons of the building. For example, in the winter, a user may program their programmable thermostat to cause the temperature in their home to drop during the day when all members of the household are at work or school, and then rise back up to a comfortable level in the late afternoon just before the members of the household are expected to arrive at home.

Current programmable thermostats generally utilize a series of buttons that a user must press to navigate through one or more menus on a digital display to select periods of time and to select temperature settings during those periods of time. Such a user interface can often be confusing to an inexperienced user trying to program the thermostat since it is often not clear how exactly to program different temperatures during different periods of time on different days of the week.

U.S. Pat. No. 6,595,430 to Shah discloses a programmable thermostat that attempts to make programming the thermostat simple and user-friendly by allowing a user to draw a graph of the temperature settings they wish to program over a 24 hour period. However, such a user interface not only requires a relatively large viewing window, but drawing and reading a graph can be intimidating to a user who is not familiar with graphs. Moreover, many users prefer the look and feel of a traditional thermostat, which often employs a wheel to select a temperature.

U.S. Pat. No. 4,837,731 to Levine et al. discloses a programmable thermostat that utilizes a wheel to allow a user to program temperature offsets from a set temperature point during selected intervals of time. However, such a design limits the flexibility of how many different temperature settings may be programmed. Additionally, once this thermostat is programmed, it is not easy to view the programmed settings or adjust or ‘tweak’ these settings.

It is an object of the present invention to obviate or mitigate at least some of the above disadvantages.

### SUMMARY OF THE INVENTION

In general terms, the present invention provides a programmable thermostat having a continuously movable indexing mechanism that allows a user to scroll or cycle through sequential time intervals ranging over a complete week to view currently programmed time intervals and to select periods of time during the week that the user wishes to program or reprogram. Preferably, the continuously movable indexing mechanism is a rotatable wheel positioned around the circumference of the thermostat.

In one aspect of the invention, there is provided a programmable thermostat comprising: (a) a viewing window for displaying an interval of time partitioned into discrete time units with the programmed temperature indicated for each of the time units; (b) a continuously movable indexing mechanism for changing the display such that a movement of the indexing mechanism by a user sequentially changes the interval of time displayed in the viewing window, the viewing window configured to display sequential time intervals ranging over a complete week through corresponding continuous movement of the indexing mechanism; and (c) one or more user input devices for setting a temperature for a selected period of time displayed in the viewing window.

In another aspect of the invention, there is provided a method of programming a programmable thermostat comprising the steps of: (a) displaying in a viewing window an interval of time partitioned into discrete time units with the currently programmed temperature indicated for each of the time units; (b) changing the display in the viewing window to display sequential time intervals based on movement of a continuously movable indexing mechanism by a user, the viewing window being configured to display sequential time intervals ranging over a complete week through corresponding continuous movement of the indexing mechanism; (c) receiving an electronic signal from one or more user input devices indicating that the user wishes to select a period of time to program; (d) selecting the period of time in response to movement of the continuously movable indexing mechanism by the user; and (e) setting a temperature to be associated with the selected period of time.

### BRIEF DESCRIPTION OF THE DRAWINGS

Embodiments of the invention will now be described by way of example only with reference to the accompanying drawings, in which:

FIG. 1 is a front view of a programmable thermostat;

FIG. 2 is a method of programming the thermostat of FIG. 1;

FIG. 3 illustrates the steps of FIG. 2 for a specific example; and

FIGS. 4 to 6 show the viewing window of the thermostat of FIG. 1 prompting and instructing a user.

### DETAILED DESCRIPTION OF THE INVENTION

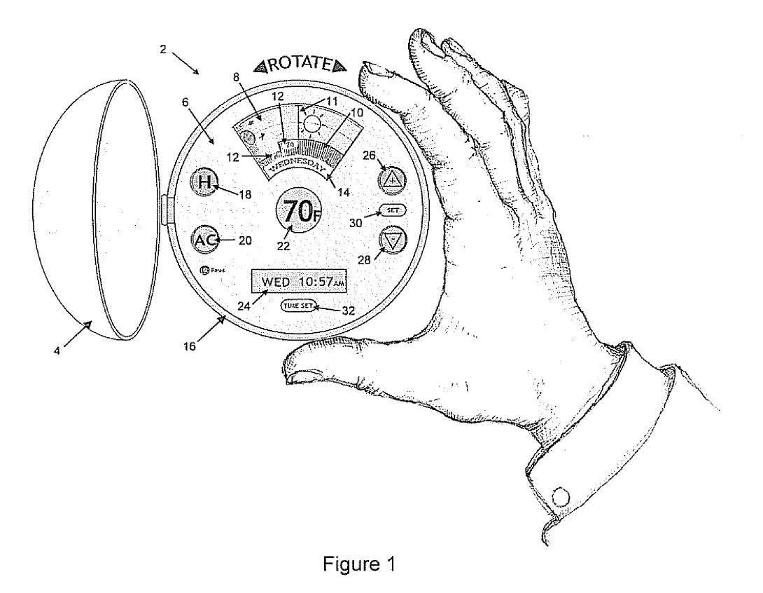

Referring first to FIG. 1, a programmable thermostat 2 is shown comprising a protective cover 4 and a user interface 6. The user interface 6 includes a viewing window 8 for displaying an interval of time, which is partitioned into discrete time units 10. The currently programmed temperature 12 is indicated for each time unit 10 by the height of each time unit 10 and by the display of the programmed temperature 12 at the beginning of each programmed interval of time. A marker 11 on the viewing window 8 serves as a reference point during the programming of thermostat 2, as will be explained in detail below. The viewing window 8 also displays the day of the week 14.

A rotatable wheel 16 is positioned around the circumference of thermostat 2 and is used to sequentially adjust the interval of time displayed in the viewing window 8. By corresponding continuous movement of wheel 16, the viewing window 8 is configured to display sequential time intervals ranging over a complete week.

The user interface 6 additionally includes an ‘H’ button 18 and an ‘AC’ button 20 for allowing a user to easily select between heating and cooling respectively. Additionally, the user interface 6 conveniently includes a display of the current temperature 22 and the current time 24. User input buttons 26, 28, and 30 allow the user to program specific temperatures for intervals of time selected using wheel 16. The operation of buttons 26, 28, and 30 will be explained in detail below.

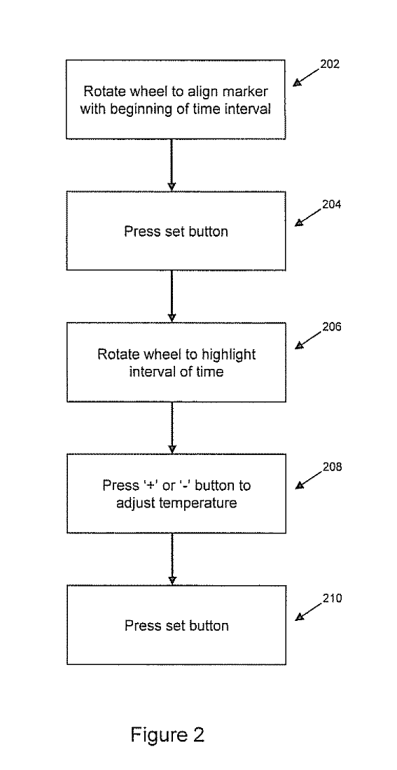

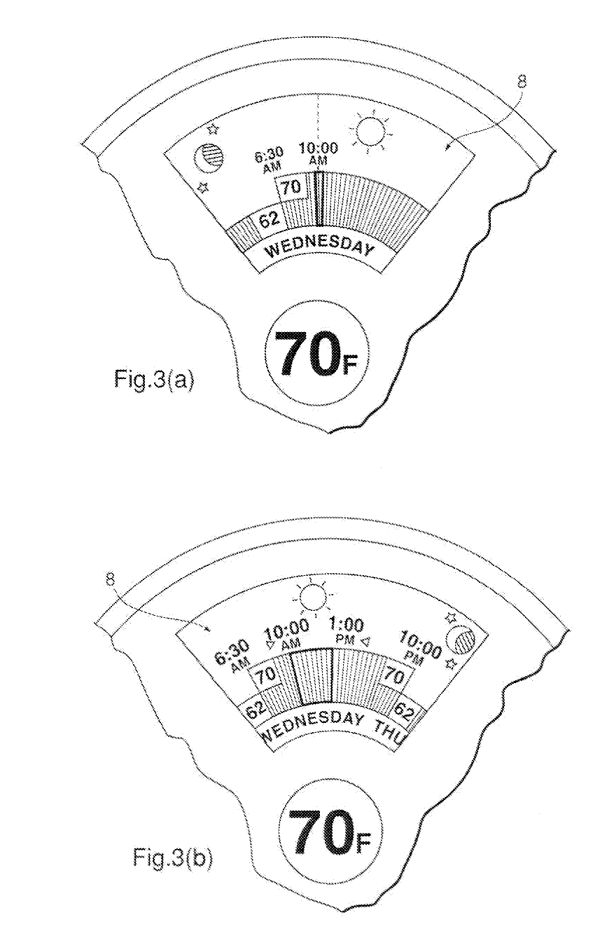

In use, a user may continuously rotate wheel 16 to correspondingly cycle through sequential intervals of time in viewing window 8 and therefore view currently programmed temperatures during any or all periods during the week. The user uses buttons 26, 28, and 30, as well as wheel 16, to select an interval of time and program a specific temperature for that interval, as will be explained now with reference to FIGS. 2 and 3.

FIG. 2 outlines an embodiment of a method for programming thermostat 2. Beginning at step 202, the user first rotates wheel 16 to align marker 11 with the beginning of the interval of time he or she wishes to program. At step 204, the user then presses the set button 30, and the unit of time aligned with the marker 11 is highlighted. An example of steps 202 and 204 is shown in FIG. 3(a) in which a user has selected 10 am on Wednesday as the beginning of the interval of time the user wishes to program. Next at step 206, the user rotates wheel 16 to sequentially adjust the interval of time displayed on viewing window 8. As the user rotates each time unit 10 past marker 11, the time unit 10 becomes highlighted. In this way, the user highlights the interval of time the user wishes to select. An example of step 206 is shown in FIG. 3(b) in which a user has continuously rotated wheel 16 to select the time interval of 10 am Wednesday to 1 pm Wednesday. During selection of the time interval to be programmed, the temperature currently programmed for the selected time interval may remain at its currently programmed temperature, but more preferably the temperature automatically defaults to a standard room temperature value (e.g. 70° F.). At step 208, the user then presses either the ‘+’ button 26 to increase the temperature during the selected interval or the ‘−’ button 28 to decrease the temperature during the selected interval. An example of step 208 is shown in FIG. 3(c) in which a user has pressed the ‘−’ button 28 to decrease the temperature during the selected interval from 70° F. to 65° F. When the user is finished adjusting the temperature for the selected interval, at step 210 the user then presses the set button 30 to finalize the programmed setting and exit the programming mode. An example of step 210 is shown in FIG. 3(d) in which a user has completed programming the selected time interval and selects the set button 30 to exit the programming mode. In the example shown in FIG. 3, the time interval of Wednesday 10 am to Wednesday 1 pm is therefore programmed for 65° F. At a later date, the user may easily view this programmed time interval by rotating the wheel 16 to display this time interval in the viewing window 8.

With the above design, it is therefore simple for a user to use wheel 16 to view the currently programmed thermostat settings during any time interval, and to use wheel 16 and input buttons 26, 28, and 30 to select any time interval during the week and program that time interval to a specific temperature. The flexibility of programming any period of time during the week to any temperature is particularly useful for users that have different schedules every day of the week and therefore desire to program unique thermostat temperature settings for each day. Moreover, thermostat 2 has the look and feel of a traditional thermostat that uses a wheel, therefore making the thermostat even more user-friendly to reluctant users who are used to traditional thermostats.

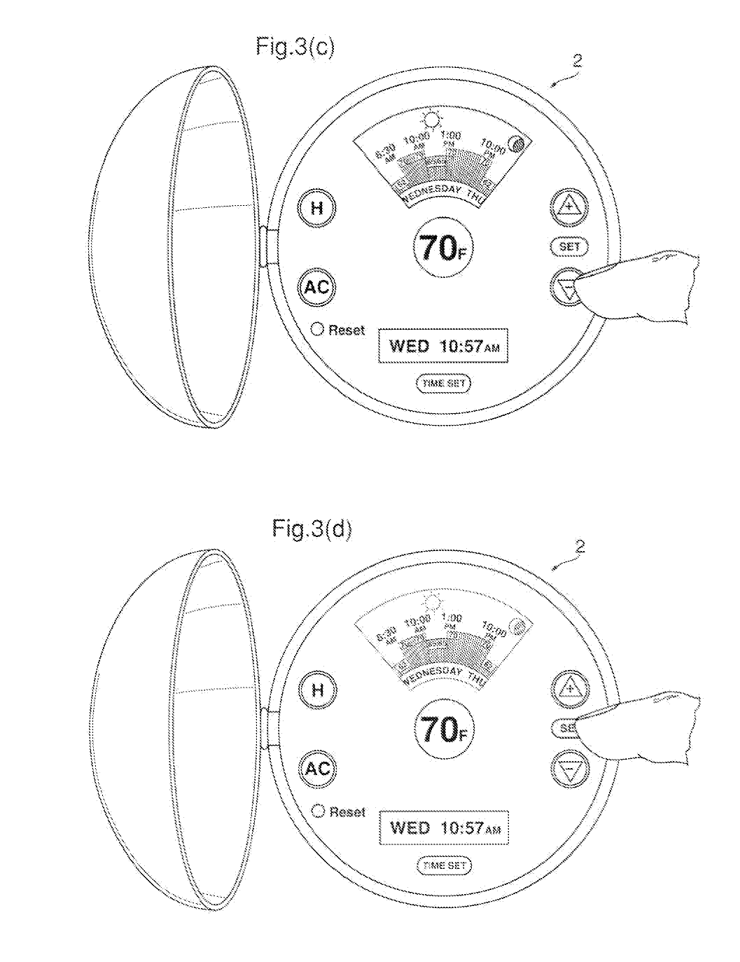

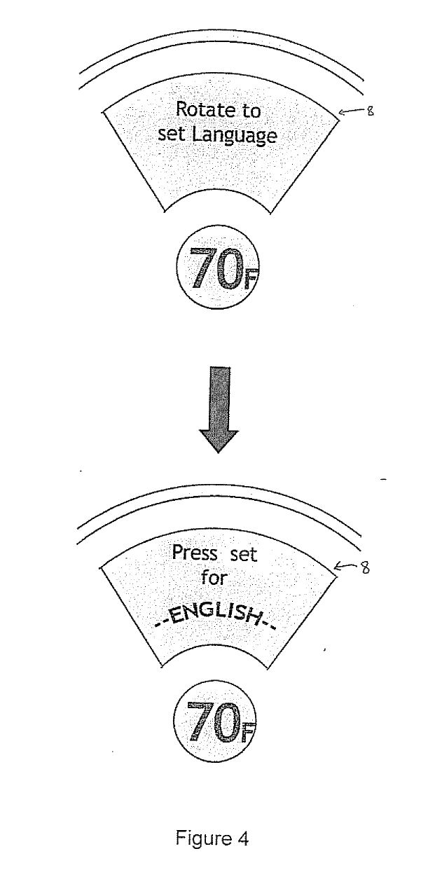

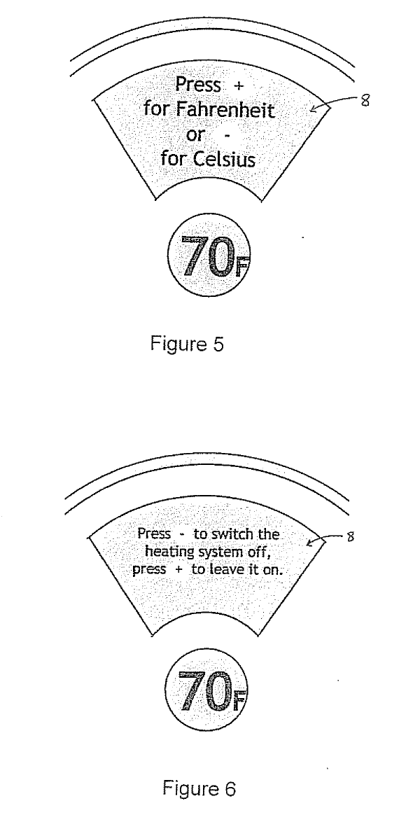

It is contemplated that the wheel 16 and user interface 6 may additionally be used to simplify the user programming of other functionalities offered by thermostat 2. For example, if the user wishes to modify the time displayed 24, the user first presses time set button 32 to initiate the mode for programming the time. It is then contemplated that the wheel 16 may be rotated to set the time (not shown). Additionally, the viewing window 8 may be used upon power-up or reset of the thermostat 2 to instruct and prompt the user to initialize the settings of thermostat 2. For example, as shown in FIG. 4, in one embodiment viewing window 8 prompts the user to select their preferred language of operation, which the user does by rotating wheel 16 and then pressing the set button 30 once their preferred language is displayed in viewing window 8. Similarly, as shown in FIG. 5, in another embodiment the viewing window prompts the user during initialization after power-up or reset to select whether the user wishes the temperature to be displayed in Fahrenheit or Celsius. The user chooses between the two by pressing either the ‘+’ button 26 or the ‘−’ button 28. Additionally, the user may be prompted and guided by the viewing window 8 when changing settings during operation. For example, in one embodiment, if the user wishes to turn off the heat, the user simply presses the ‘H’ button 18. As shown in FIG. 6, after the ‘H’ button 18 is pressed, the viewing window 8 displays instructions prompting the user to confirm the choice by pressing either the ‘+’ button 26 or the ‘−’ button 28. In this way, the viewing window 8 of the thermostat 2 prompts and/or instructs the user as to the next steps to be performed when initializing or changing thermostat settings.

Although the invention has been described with reference to certain specific embodiments, various modifications thereof will be apparent to those skilled in the art without departing from the spirit and scope of the invention as identified in the claims appended hereto.

For example, whilst the continuously rotatable wheel 16 offers a convenient mechanism for sequentially cycling or scrolling through time intervals ranging over a complete week, it will be appreciated that any continuously movable indexing mechanism may be used, such as a touch-sensitive annular surface, a rotatable knob, or even a simple lever. Additionally, it is contemplated that during programming of the thermostat many other types of user input devices may be used instead of buttons 26, 28, and 30 for setting the temperature once the time interval is highlighted by wheel 16. For example, instead of buttons 26 and 28, a small wheel, lever, knob, touch-sensitive annular surface, or any other device that can perform the same functionality may be used by the user to adjust the temperature up or down during step 208 of the method of FIG. 2. Wheel 16 may even itself be used to adjust the temperature. For example, in an alternative embodiment, at step 208 the user presses set button 30 to temporarily change the functionality of wheel 16 to adjust temperature instead of select a time interval. The user may then rotate wheel 16 clockwise to increase the temperature or counter clockwise to decrease the temperature. The user then presses set button 30 again at step 210 to finalize the programmed setting, return wheel 16 to its normal functionality of cycling through sequential time intervals, and exit the programming mode.

What is claimed is:

1. A programmable thermostat comprising:
(a) a viewing window for displaying an interval of time partitioned into discrete time units with the programmed temperature indicated for each of said time units;
(b) a continuously movable indexing mechanism for changing the display such that a movement of said indexing mechanism by a user sequentially changes the interval of time displayed in said viewing window; said viewing window configured to display sequential time intervals ranging over a complete week through corresponding continuous movement of said indexing mechanism; and
(c) one or more user input devices for setting a temperature for a selected period of time displayed in said viewing window.

2. The programmable thermostat of claim 1 wherein said continuously movable indexing mechanism is a rotatable wheel.

3. The programmable thermostat of claim 2 wherein said thermostat has a circular profile and said rotatable wheel is positioned around the circumference of said circular profile.

4. The programmable thermostat of claim 1 wherein said one or more user input devices comprises one or more buttons.

5. The programmable thermostat of claim 4 wherein said indexing mechanism is further configured to select said selected period of time when one of said one or more buttons is pressed by a user.

6. The programmable thermostat of claim 1 wherein said week is partitioned into seven days and wherein each day corresponding to said interval of time displayed in said viewing window is also displayed in said viewing window.

7. The programmable thermostat of claim 1 wherein said indexing mechanism is selected from the group consisting of: a touch-sensitive annular surface, a lever, and a rotatable knob; and wherein said one or more user input devices is selected from the group consisting of: a touch-sensitive annular surface, a lever, a rotatable knob, and a rotatable wheel.

8. The programmable thermostat of claim 1 further comprising an input for selecting heating or cooling.

9. The programmable thermostat of claim 8 further comprising a display for displaying the current time and an input for modifying the current time displayed.

10. The programmable thermostat of claim 1 wherein said viewing window is further configured for intermittently prompting or instructing a user.

11. A method of programming a programmable thermostat comprising the steps of:
(a) displaying in a viewing window an interval of time partitioned into discrete time units with the currently programmed temperature indicated for each of said time units;
(b) changing the display in said viewing window to display sequential time intervals based on movement of a continuously movable indexing mechanism by a user; said viewing window being configured to display sequential time intervals ranging over a complete week through corresponding continuous movement of said indexing mechanism;
(c) receiving all electronic signal from one or more user input devices indicating that said user wishes to select a period of time to program;
(d) selecting said period of time in response to movement of said continuously movable indexing mechanism by said user; and
(e) setting a temperature to be associated with said selected period of time.

12. The method of claim 11 wherein time units of said selected period of time are selected by said user moving said indexing mechanism to cause movement of said time units past a marker on said viewing window.

13. The method of claim 11 wherein the step of setting a temperature comprises adjusting the temperature up or down based on electronic signals received from said one or more user input devices.

14. The method of claim 11 wherein said continuously movable indexing mechanism is a rotatable wheel.

15. The method of claim 14 wherein said thermostat has a circular profile and said rotatable wheel is positioned around the circumference of said circular profile.

16. The method of claim 11 wherein said one or more user input devices comprises one or more buttons.

17. The method of claim 11 wherein said week is partitioned into seven days and wherein each day corresponding to said interval of time displayed in said viewing window is also displayed in said viewing window.

18. The method of claim 11 wherein said indexing mechanism is selected from the group consisting of: a touch-sensitive annular surface, a lever, and a rotatable knob; and wherein said one or more user input devices is selected from the group consisting of: a touch-sensitive annular surface, a lever, a rotatable knob, and a rotatable wheel.

19. The method of claim 11 further comprising the step of intermittently prompting or instructing said user.
